(19) United States
(12) Patent Application Publication
(10) Pub. No.: US 2013/0268444 A1
(43) Pub. Date: Oct. 10, 2013

(54) THREE-FACTOR USER AUTHENTICATION METHOD FOR GENERATING OTP USING IRIS INFORMATION AND SECURE MUTUAL AUTHENTICATION SYSTEM USING OTP AUTHENTICATION MODULE OF WIRELESS COMMUNICATION TERMINAL

(71) Applicants: Jong Namgoong, Gyeonggi-do (KR); Insun Kim, Gyeonggi-do (KR)

(72) Inventors: Jong Namgoong, Gyeonggi-do (KR); Insun Kim, Gyeonggi-do (KR)

(21) Appl. No.: 13/700,494

(22) PCT Filed: May 18, 2011
(86) PCT No.: PCT/KR2011/003668

§ 371 Date: Feb. 6, 2013

(30) Foreign Application Priority Data
May 28, 2010 (KR) 10-2010-0050254

(51) Int. Cl. G06Q 20/40

(52) U.S. Cl. CPC G06Q 20/40145; H04L 63/08
USPC 705/71; 726/4

(57) ABSTRACT

The present invention authenticates a user using iris information in order to generate OTP, generates OTP using a 3-factor authentication method based on HMAC, and performs encryption thereof, and also relates to a security system that secures and controls a wireless communication terminal owned by a user through the following methods: a method for managing the storage of a program memory having a management program and encrypted key values stored therein, by directly inputting the iris information in real-time; a method for authenticating a wireless communication terminal by mutually authenticating two methods having different directions, the methods being an authentication by an OTP integrated authentication server through a service providing server, and an authentication by a public authentication facility through a wireless authentication server; a method for enabling the service usage of packets for communication between a user and a server only through iris authentication in order to prevent a DoS attack during the communication; and a method for protecting the system by protecting the original and patch files of the applications and the drives using iris information and constantly monitoring same, thus enabling secure electronic transaction services.

### TECHNICAL FIELD

The present invention relates to a three-factor user authentication method for generating an OTP using an iris information and a secure mutual authentication system using an OTP authentication module of a wireless communication terminal, and in particular to a method for safely authenticating users in real time and managing major encryption keys in safe using an iris to make sure that what a randomly modulated packet is inserted or a user identification is counterfeited can be prevented in such a way that an authentication module including an iris camera is used for the purpose of obtaining a safety in case of an electronic authentication and an electronic payment signature for the sake of a user authentication, a financial transaction and a payment in the course of an electronic transaction, an internet banking, etc., and an authentication module including an iris camera is used, and all packets are digested using a user's iris information whenever a user makes a login, and a result of it is attached to a corresponding packet and is transmitted.

### BACKGROUND ART

First of all, the most common and easiest approach method is to use a combination of an ID/password as a user credential means. In other words, a fixed password-based user authentication method is directed to recognizing a user by way of an encrypted transmission of a user credential and a DB matching, so it can be easily implemented and is proper to a system which does not need a high level security; however it has a disadvantage that information can be exposed carelessly.

1) The passive adversary should be safe from an eavesdropping. The eavesdropping is directed to finding out the information of a session key by tapping an online communication content or it is a kind of an attack for finding out a useful information used on the communication.

2) The active adversary should be safe from a replay attack and a man in the middle attack.

The replay attack is directed to an attack that an attacker stores a message used by a legal user in the past and retransmits it on the communication.

The man in the middle attack is a kind of an attack for the purpose of obtaining a session key between legal users in such a way that an attacker positioned at an intermediate portion of a communication line illegally taps an information between a server and a user and transmits it.

3) It should be safe from the offline password guessing attack.

The offline password guessing attack is a kind of an attack which is generally conducted when an attacker has a dictionary on the passwords that users often use. The attacker compares a value matching with a password used in the past communication with the password dictionary and finds out it.

4) It should be safe from a Denning-Sacco attack.

The Denning-Sacco attack is a kind of an attack used so as to obtain information on a user's password or information on a session key to be used in the coming session based on the information that the attacker has collected when a session key is exposed.

5) The perfect forward secrecy should be satisfied.

The perfect forward secrecy features in that even when the attacker finds out a user's password or a long term password identifier of the server, the information on the session which was used before cannot be found out.

Second, in case of PGP disclosed as the encryption and decryption technique so as to support the encrypted transmission of the email, the authentication is performed using the X.509 certificate of PKI and the PGP certificate of another structure. In other words, the PKI is dependent on a central authority (CA); whereas PGP includes the key/identifications (self-signature) of multiple users for one certificate, so it operates as a system configured to judge the validity of the keys between the users. All the users in the PGP technique performs as a validator who identifies others, so constructing the web-of-trust”, and the PGP user under the above mentioned environment judges a trust between them by way of the reputation technique such as a vote counting; however PGP might use a qualification certificate structure similar with PKI by way of the central trusted authority like CA.

Third, PKI is widely used in Korea as a public authentication method, and in particular most of the transaction systems including banks are mainly dependent on PKI; however PKI does not provide any relationship between counties in case of CA which performs a key function. For the sake of a certificate issuance, each person is requested to have an offline registration while making sure a strong authentication; however lots of problems occur due to the centralization of the personal information.

The certificate is issued by way of a very strict procedure while producing a legal effectiveness when in use, and it is costly to use the certificate on an ordinary internet site along with other problems. If ID and password leak due to the hacking or fishing which frequently occur on the internet, the certificate might be stolen by way of the reissuance of the certificate, so a secondary system for supporting the certificate system is needed. The code input method using a conventional security card (random number code card) has still a problem that it might be easily hacked because the number of code numbers is small.

The above mentioned characteristics of PKI function as a key factor lowering the applicability to a wireless terminal. In addition, in case of HSM which is designated as a first class security medium from the financial supervisory service along with OTP, it depends on the security token, so the leakage of the private key can be prevented, and the decryption and signing procedures are performed in the interior of the security token. It is advantageous that the decryption and signing procedures are performed in the interior of the security token. However, the authentication method of HSM depends on the infrastructure of a public key and the hardware medium, so the specific relationship with the wireless terminal seems to be hard. Next, the self-assigned technique is directed to generating the public keys with the aid of a peer itself and performing an authentication and identification without having an aid from the central authentication organization under the distributed network environment, which seems to be an idea-like methodology. For the sake of an application of it, a trust relation based on a P2P community or a group, the designation of a delegator performing the authentication and the definition on the protocols are needed. The above mentioned method is currently under development, and the applicability is low.

As briefly explained in the above, lots of considerations including a surfaced security requirement should be considered so as to directly apply the public key-based authentication system to the wireless terminal. It is meaningful that the technology of the wireless terminal authentication mechanism provides a key means for directly connecting the ubiquitous service model to the industry. So, it is time to suggest a security mechanism structure which can provide a flexible and strict authentication for the purpose of establishing and performing a security policy which is proper to the wireless network environment.

Fourth, the technology related with OTP will be described. The patent application number 1019990000554 provides a function generating an OTP value based on the time sync method in a communication terminal apparatus supporting a bidirectional communication and performs an authentication procedure using an ARS and a communication system. In the normal communication mode, a transmission and receiving function is provided for the sake of a voice communication and a data communication. The personal identification number inputted by way of a user input part is compared with the identification number provided in the communication device. If they are matched, an access to the first authentication token mode and the second authentication mode is allowed. The first authentication is received or the time value of the communication terminal itself is substituted with a challenge value and is used. The second authentication is transmitted by generating a response (OTP) by receiving the challenge value, so the user's authentication is performed in the system. As the variable included in the generation of the reference value, if only the challenge value (or time value) is used to generate the reference value, since the OTP can be generated using any terminal, the number of the users that the system can authenticate is limited to one person. If the IN value is reflected to the generation of the reference value, the management thereon might be the key element. When there is not any mention on the management methods, it means that the management is not accurate. When a third party reports the loss of the authentication token system or can receive by way of the re-request, and when the information on the PIN value of the staff in the office managing the authentication server is leaked, the PIN value is open with the password used so as to make an access to the token mode. When the method for generating the challenge value is leaked, it can be generated anywhere, which causes a serious problem. To generate the reference value, it is needed to always keep communicating with the authentication server.

In addition, the single direction Hash function f is f:X->Y(|X|>|Y|). A pair of collisions exist in the single direction Hash function. The conventional OTP token uses SHA-1 and HAS-160; however the decrypting possibility of the Hash algorithms SHA-1 and HAS-160 which is widely used throughout the world by the difference attach of Professor Wang who is Chinese encryption scholar has been proved.

The OTP authentication means a method for authenticating the objects using the active password which changes at every session. As the elements for the purpose of authenticating the objects, there are three elements: something you know/password, PIN, something you have/ID card, smart card, security token, cellular phone, smart phone) and something you are (biometric identifier/iris, fingerprint, voice, face). The conventional OTP authentication method is directed to using a 2-factor authentication method based on something you know and something you have. It can be classified into a question-response method, an event sync method, a time synchronization method and a combination method. The OTP generation medium for the purpose of generating the OTP is a dedicated H/W OTP token and a mobile OTP equipped with an OTP generation function using software and a card type OTP.

A) Question-Response Method

The question-response method is directed to a method in which a user directly inputs the question value from the OTP authentication server for thereby generating an OTP. When a security problem, it is possible to easily find out a person who is in charge. Since the question and answer values are communicated, the mutual-authentication is possible.

As a representative question-answer method, it is to use the security card when using the phone banking or the internet banking.

B) Event Synchronization Method

As a representative event synchronization method, there is a S/Key method. This method is introduced on the standard RFC1320 of the Internet Engineering Task Force and is directed to the system operating based on the MD4 message digestive algorithm.

The procedure of the operation of the S/Key OTP system might be considered based on the sides of a client and a server. If it is assumed that n=4, the server stores Xn+1=f(f(f(fx)))). The client generates and transmits Xn=f(f(f(f(x)))) to the OTP. The server calculates Xn+1=f(Xn) for the sake of authentication. Finally, the server generates Xn+1=f(Xn) by setting Xn+1 with Xn if the authentication is succeeded. In addition, n-value increases by 1.

C) Time Synchronization Method

The time synchronization method is directed to generating a new password every minute at a specific time interval based on the synchronized time information between the server and the OTP token.

D) Combination Method

The combination method is a method sharing the time synchronization method and the event synchronization method so as to supplement the disadvantages of the time synchronization method which needs to wait one minute for generating a new OTP and the event synchronization method which needs a resynchronization when the synchronization of the counter value is wrong. The combination method is most widely used among the authentication methods using OTP.

Fifth, with regard to the technology related with the SMS, the Korean patent application number 1019990057586 comprises a wireless terminal of a customer, a server having a database with a customer's ID and a wireless terminal code and configured to communicate the data with the wireless terminal using the wireless communication, and an input means connected to the server by way of a wired or wireless communication or the internet and configured to input the customer's ID and authentication key. When a customer inputs the ID using the input means, the server determines a certain authentication key, and transmits to the customer's wireless terminal belonging to the ID. When the customer inputs the received authentication key on the wireless terminal by way of the input means, the server compares the authentication key transmitted to the wireless terminal with the authentication key inputted by way of the input means for thereby identifying the personal identity of the customer. The method inputting it by receiving an authentication code by way of SMS is being rejected from grand over the U.S. Pat. No. 5,608,778 (filed on Mar. 4, 1997). The third party can easily receive the authentication when the wireless terminal is missing or the copied cellular phone is used.

As the computer and communication technology advances, almost information services are performed online. The online information is considered as valuable information. As the hacking technology advances, various attacking technologies are being developed. In order to provide a safe internet environment by protecting it from such attacks, the static password system of the common ID/password method is not used, but an OTP is generally used, which is directed to generating a new password every time. It is considered as the first class security method. Nowadays, a 2-factor OTP generation method using an OTP token is mainly used.

The above mentioned 2-factor authentication method does not suggest a protection plan with respect to a collision of a single direction Hash function and the missing of the OTP token or a physical attach such as a robbery. The present invention is directed to providing a 3-factor authentication method based on HMAC using an iris information so as to overcome the above mentioned problems.

The iris information among the biological information is used because the fingerprint and voices have faking dangers, and most of the currently available wireless terminals are equipped with an advanced image recording camera. When an iris camera is built using such advanced cameras, it is possible to save the costs needed for the development.

In the online service, the denial of service (DoS) attack is designed to interrupt a plurality of legal users from using services, which is performed by way of the SYN flooding. It has a problem that the targets to be attacked are searched by searching valid ports before the DoS attack. In the method of a packet level user using an iris information according to the present invention, so as to overcome the above mentioned problems, all the packets are authenticated using the iris information from the moment that the SYN packet is transmitted, thus incapacitating the DoS attack or valid port searches.

Finally, it is directed to maintaining the security and integrity of the wireless communication terminal operating system.

When a malicious software specially designed to damage the system or interrupt the same penetrates into the wireless communication terminal, the operating system of the wireless communication terminal and the integrity of the whole wireless communication terminal system are severely damaged. The interests in the security and condition of the users of the wireless communication terminal are wide; however virus, worm and Trojan attack occur, the users have interests in the integrity features of the very important infrastructure components of the wireless communication terminals such as operating system processors, memory processors, etc.

One way for protecting the wireless communication system and its operating system is to install a set of the security applications like an anti-virus software, a personal firmware, a malicious code infection system alarm solution, a patch management system (PMS) and a penetration detection system.

Each wireless communication terminal system is configured to execute a set of the security applications. Since such security applications are weak, it might be not enough to protect the wireless communication terminals.

### DISCLOSURE OF INVENTION

Accordingly, it is an object of the present invention to overcome the disadvantages of the conventional authentication method.

It is another object of the present invention to provide a user authentication method which is portable and safe from the missing of an OTP token or a physical attack such as a robbery and a collision of a single direction hash function because the present invention is directed to a 3-factor authentication method based on a HMAC using an inherent value obtained from a user's iris information in real time which corresponds to an inherent secret value of a user in a user authentication module.

It is another object of the present invention to provide a user authentication method using an iris information supporting a user's convenience in such a way to provide a means which helps automatically input from a distant place to a service providing (financial organization) server with the aid of an authentication module without using a manual key input with respect to a user's inherent basic key generation, storing, managing and registration which are obtained from a user's iris information value.

In the present invention, it is another object of the present invention to provide a packet level user authentication method using an iris data featuring in that all the packets between the wireless communication terminal and the service providing (financial organization) server are transmitted in such a way to insert a result obtained after the IP data is digested using a digest key with respect to a user's iris information, so a randomly forged packet's insertion and an illegal use of a user's identity can be interrupted. In particular, the iris information is inserted and authenticated at the time of the SYN packet transmission, thus incapacitating the DoS attack or valid port searches.

Finally, the set of the applications and the monitoring processes can operate on the wireless communication terminal and the host system of the computer. The security technology provides a security with respect at least one independent operating environment which is executable on the wireless communication terminal. The security technology comprises a step for implementing the security applications which can be controlled by the monitoring processes. The security application can monitor at least one virtual machine. This monitoring is directed to searching offline the virtual machines by mean of the security applications, and the agent security process can be implemented on the virtual machines.

As another attempt to protect the wireless communication terminal system and its operating system, the elements of the wireless communication terminal system such as the memory and the driver are separate from the elements of the wireless communication terminal system, thus protecting them.

### Advantageous effects

As described above, the authentication module of the user using the iris information according to the present invention is a software type OTP authentication module. The user's iris information is recognized and it can be used as a conceal master key recovering the password key values. The present invention can provide an easy and safe authentication method which does not need to store the password or to carry it.

The present invention provide a function of managing the secret key and signature key using a user's iris information so as to provide a tamper proof function helping achieve a safe management of a software type OTP master key and a software type OTP value generation procedure and an external software and physical attack by way of a user's iris information. In case of the software type OTP authentication module, a user does not need to input in person the random OTP values that the user has generated, into the wireless terminal, so the software type OTP generation values can be automatically inputted into the service page of the wireless terminal in easier and safer ways, thus maximizing the user's convenience.

The multiple registration method of the software type OTP authentication module provides a mechanism by which one software type OTP authentication module can be registered in the multiple service organizations for a user who uses multiple financial organization, so it is possible to provide a safety, convenience and cost-effective functions as compared to the conventional authentication device. It is not needed to carry multiple software type OTP, and the user registration can be performed in the multiple financial organizations from a distant place using a network, so the user convenience can be maximized.

In addition, the present invention makes it impossible for a third party to insert a forged packet, and if necessary, the user is requested to input again a biological information, so the user can be authenticated in real time. It is possible to prevent to effectively cope with the illegal use of the password and the Internet banking hacking accident by the certificate robbery.

The wireless communication terminal security technology according to the present invention is directed to monitoring and protecting the virtual machines which are logically isolated and executable on the wireless communication terminal system with the aid of the single security process (or a set of the security processes) while providing various security characteristics.

### BRIEF DESCRIPTION OF DRAWINGS

FIG. 1 is a block diagram illustrating a construction of an authentication module of a user who uses an iris information on a wireless communication terminal to which is attached an image input device according to the present invention.

FIG. 2 is a flow chart of an initial offline face-to-face identity check procedure so as to issue a user OTP authentication module of a wireless communication terminal.

FIG. 3 is a view of an example of an iris process part for the sake of an issuance of a user OTP authentication module of a wireless communication terminal.

FIG. 4 is a flow chart of an initial security module part for the sake of an issuance of a user OTP authentication module of a wireless communication terminal.

FIG. 5 is a flow chart of an initial (initialization) key setup procedure with a key generation part sing an iris information for the sake of an issuance of a user OTP authentication module of a wireless communication terminal.

FIG. 6 is a flow chart of the whole authentication procedures of an mutual-authentication using an OTP authentication module of a wireless communication terminal.

FIG. 7 is a flow chart of a packet level user authentication method using an iris data for the purpose of preventing a DoS attack on a network section between a wireless communication terminal and a service provision server communication module part.

FIG. 8 is a view illustrating a check DB record of a check of an original file and a patch file which are used for checking so as to maintain the security and integrity of a wireless communication terminal operating system.

FIG. 9 is a view illustrating a construction of a virtual machine and a terminal physical system for the sake of the security of a wireless communication terminal operating system.

### BEST MODES FOR CARRYING OUT THE INVENTION

In the drawings, the following descriptions are intended to provide the detailed descriptions for the sake of the full understanding and possible descriptions of the embodiments of the present invention. It is obvious that an ordinary person skilled in the art could implement without the detailed descriptions. In other occasions, the known structures and functions will be omitted from the drawings and descriptions when it is considered that they could make unclear the subject matters of the present invention.

Though the terms suggested in the descriptions are related with the special embodiments of the present inventions, they should be interpreted in the most reasonable ways. The specific terms might be emphasized in the following. A certain term intended to be interpreted in a certain limited way should be defined as having a special meaning in the descriptions of the invention.

The preferred embodiments of the present invention will be described with reference to the accompanying drawings.

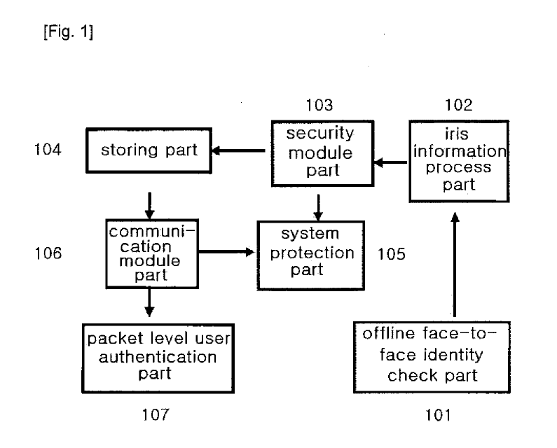

FIG. 1 is a block diagram illustrating a construction of an authentication module of a user who uses an iris information on a wireless communication terminal to which is attached an image input device according to the present invention.

As shown in FIG. 1, the user authentication module using an iris information on the wireless communication terminal comprises an initial offline face-to-face identity check part (S101) for receiving an issuance of the user OTP authentication module of a wireless communication terminal; an iris information process part (S102) formed of an iris camera taking a user's iris image of the wireless communication terminal and extracting the feature of an iris information and performing a digital process; a security module part (S103) for authenticating a user using an iris digital code for the sake of a registration and mutual-authentication of a user OTP module of a wireless communication terminal and for generating an OTP and performing an encryption process; a storing part (S104) formed of a program memory storing an encryption algorithm and an operating program and storing the encrypted key values; an mutual-authentication part (S106) for transmitting and receiving a data between the wireless communication terminal and the service providing server and the mobile authentication server (MAS); a packet level user authentication part (S107) using an iris information so as to prevent the DoS attack on the communication line; and

the system protection part (S105) using the iris information so as to prevent the malicious code and virus attacks on the network.

The preferred example of the present invention features in that the initial offline face-to-face identity checking procedure for the sake of the issuance of the user OTP authentication module as to the wireless communication terminal user authentication using an iris information in the online electronic commerce transaction according to a preferred embodiment of the present invention is checked to confirm that the real name of the financial service request customer is within the real name confirmation period in compliance with the financial real name check procedure corresponding to the law on the financial real name transaction and the security guarantee and its enforcement ordinance (Presidential ordinance number 15744).

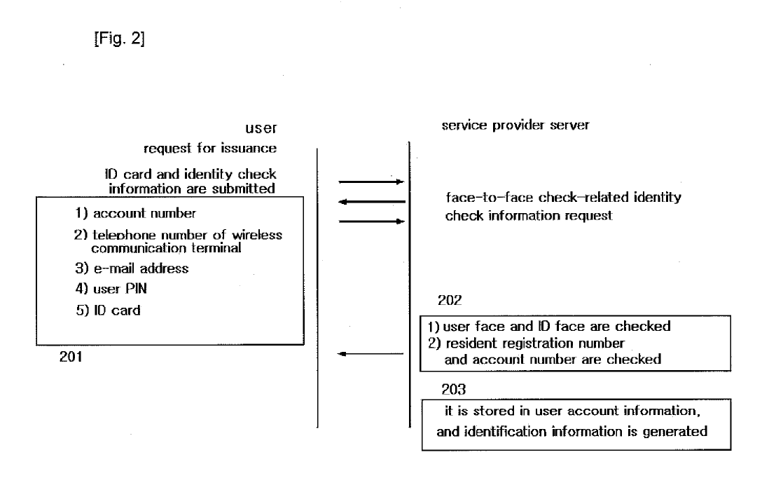

FIG. 2 is a flow chart of an initial offline face-to-face identity check procedure so as to issue a user OTP authentication module of a wireless communication terminal.

OFF Line

First of all, the following procedures are completed by visiting the service provider (financial organization).

1) An OTP authentication software issuance of the user of the wireless communication terminal is requested to the service provider (financial organization).

2) The service provider (financial organization) requests (S201) to the user the user identity check information and the identification card (resident registration number) such as the account number, the wireless communication terminal cellular phone number (used for the user ID), the Internet e-mail address and the user PIN. When the user submits the identification card (resident registration number) and the requested user identity check information, the service provider checks the user's face and the identification card face and the resident registration and the account number, and the face-to-face identity check procedure is finished (S202).

The user PIN (Personal Identification Number) includes at least one information among the platform information (PFN) of the user's wireless communication terminal on which is mounted the OTP authentication module, and the serial number (ESN) and further includes an inherent serial value which is mounted at the time of the manufacture of the OTP authentication device in which is stored the communication company information of the wireless terminal and the terminal model information in attaching or storing ways.

According to the embodiment of the present invention, the wireless terminal information might include at least one information item depending on the developer's intension. For example, the wireless terminal information might further include an IC chip inherent information (ICCHIP) in the IC chip which is mounted on or detachably mounted on the wireless terminal. In case that a subscriber identity module (SIM) or a universal identification module (UIM) or a universal subscriber identity module (USIM) is provided, there might be further provided a SIM information or a UIM information or a USIM information.

3) The service provider (financial organization) stores the user identity check information submitted after the check of the identity into the user's account information of the service provider (financial organization) and generates the identification information (S203).

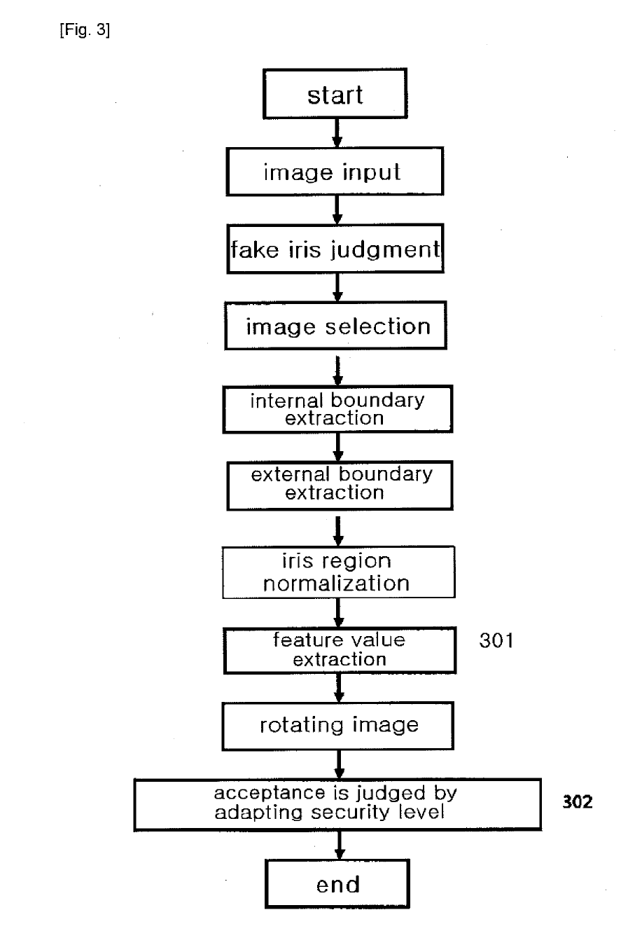

FIG. 3 is a view of an embodiment example of an iris process part for receiving a user OTP authentication module of the wireless communication terminal of FIG. 1. (S302, S302).

According to a preferred embodiment of the present invention, the iris camera taking a user's iris image of the wireless communication terminal and the iris information process part extracting the features of the iris information and performing a digital code process are well disclosed in the patent application 10-2007-0015189 filed by the same applicant as the present application, and they are in compliance with the regulations related to the user authentication on the biological information such as fingerprints and iris in the information and communication network law (article 15) and the enforcement ordinance of the resident registration law (article 49) and the electronic signing law (article 2, paragraph 13).

In the present invention, it is illustrated that the iris camera is adapted for the sake of the iris recognition; however the camera taking various biological information such as fingerprint and face might be used.

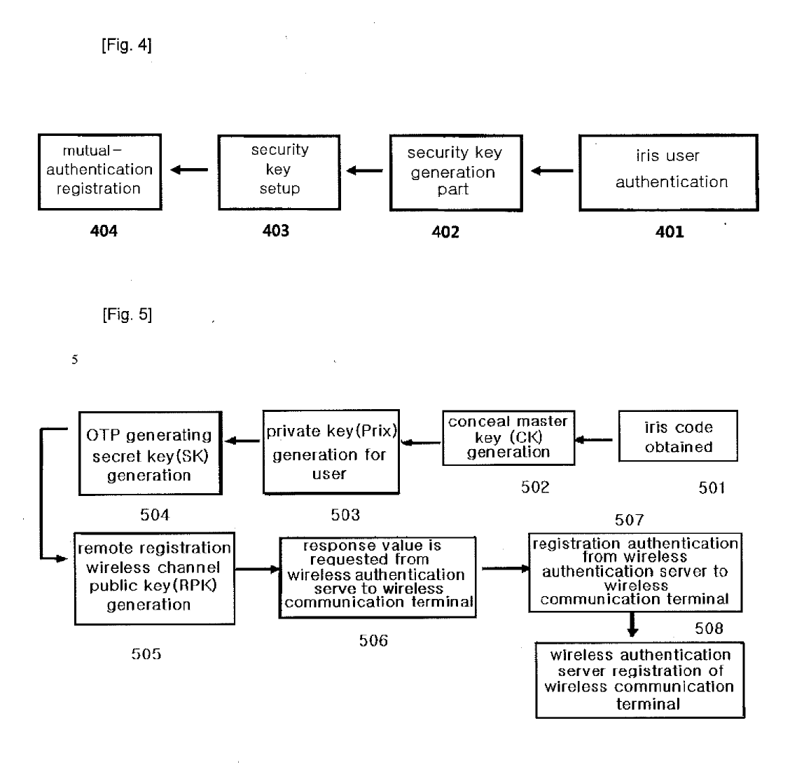

FIG. 4 is a flow chart of the initial security module part for the purpose of receiving a user OTP authentication module of the wireless communication terminal of FIG. 1.

The key generation part (S402) configured to authentivate (S401) the user using the iris digital code and to generate the OTP and perform the encryption process for the sake of the registration of the user OTP module of the wireless communication terminal and the bidirectional mutual-authentication comprises:

an initial (initialization) key setup (S403) step for the sake of the user OTP authentication registration of the wireless communication terminal; and

a mutual-authentication registration (S404) step using the OTP authentication module of the wireless communication terminal.

According to a preferred embodiment of the present invention, the initial key generation and key setup (initialization) procedures will be described, which procedures are performed after all the offline initial face-to-face identity check procedures are finished for the sake of the user authentication registration with the aid of the user OTP authentication module of the wireless communication terminal adapting the WiFi module in the communication module part.

FIG. 5 is a flow chart of the key generation part using the iris information and the initial (initialization) key setup procedure for the sake of the user OTP authentication module issuance of the wireless communication terminal of FIG. 4. The procedure comprises a step (S501) for obtaining an iris code from the user's iris information by means of the iris process part, a conceal master key (CK) generation step (S502) by means of the key generation part, a user persona key (PriK) generation step (S503), a software type OTP generation secret key (SK) generation step (S504), a distant registration wireless channel public key (RPK) generation step (S505), a response value request step (S506) with respect to a wireless communication terminal from the mobile authentication server (MAS), a registration authentication step (S507) of a wireless communication terminal and a mobile authentication server registration completion step (S508) of the wireless communication terminal.

1) The iris information feature point extraction step of the iris process part will be described. The user's iris image is taken using the iris recognition camera, and only the iris region is separated from the inputted iris image, and the feature point of a corresponding iris information is extracted from the separated user iris information and is converted into a digital code value, thus obtaining the iris code, which is already disclosed in the patent application number 10-2010-0041372 filed by the same applicant as the present invention.

The present invention discloses an example that the iris camera is adapted for the sake of the iris recognition; however a camera measuring various biological information such as fingerprint and face could be adapted.

2) Next, the procedure generating the conceal master key value of the security module part is performed as follows.

The feature codes of the user are obtained in real time, and the iris code is not stored, and the iris code value on the first track coordinate of the reference angle (sector) is determined as the filter, and the encryption key can be concealed along the hiding of the iris information. At this time, the filter formed based on the iris information of each person for the sake of the method of extracting the iris feature value and the hiding is well disclosed in the patent application number 10-2010-0041372 filed by the same applicant as the present invention.

In this method, the iris code value is not directly stored, so the iris information can be concealed, and since it is impossible to extract the iris code or the encryption key stored in the interior from the filter without inputting in real time the iris information of each person, a high level security can be maintained.

The present invention features in that the hiding (encryption) of various conceal key values can be managed with the iris code values. The key/code used for the sake of encrypting the conceal key values are defined as a conceal key (CK), and the hash value using the user PIN value and the generated iris filter value as the factors is taken and used as the CK value.

3) The next stage is the private key and secret key calculation step. In the software type OTP authentication module, the user iris information-based authentication is performed, and when the CK value is calculated, the hash value thereon is calculated, and the user private key value (PriK) is generated, and the encryption is performed using the CK value in safe so as to use as the reference value for the user authentication whenever the user logs in, and the encrypted value is recorded in the storing part.

The secondary hash value is calculated with reference to the value of the private key (PriK), thus generating a software type OTP generation secret key (SK), and the above value is used as the secret key needed when generating a software type OTP, and it is encrypted with the CK value for managing it in safe, and the software type OTP generation secret key is recorded in the storing part in safe.

Registering the user's OTP means that the SK value is registered. The PinK value is encrypted and transferred for the purpose of verifying the safe transmission and the true software type OTP authentication module with respect to the channel between the software type OTP authentication module of the wireless communication terminal and the PC and the service providing server. In other words, encryption the SK value by using the PriK value as the key is for the sake of the safety of the channel which is first handed over, and the decryption of the user information should be correctly performed at the side where it is secondarily handed over, so it is proved that the user software type OTP authentication module is actually transmitted.

4) In addition, the channel master key (RPK) is needed for the purpose of remotely registering the wireless communication terminal in the mobile authentication server (MAS). For this, the hash value induced from the cellular phone number of the wireless terminal is stored as the remote registration wireless channel public key value and is managed.

5) The following step is a response value request step with respect to the wireless communication terminal from the mobile authentication server (MAS). For the sake of the user registration, a safe encryption channel is formed based on SSL and PKI between the wireless terminal of the side of the user and the mobile authentication server (MAS) server. When a safe channel is formed, the mobile authentication server (MAS) generates a random number challenge value N for the sake of the user authentication and transmits it to the user wireless communication terminal along with the server ID.

6) The next step is a registration authentication step of the wireless communication terminal at the mobile authentication server. The user wireless terminal generates a response value with respect to the ID transmission of the mobile authentication server (MAS) and the random number challenge value N.

As the basic response value calculation step, the hash value H:=Hash(IDs, SK, N) is calculated with respect to the ID(IDs) of the mobile authentication server and the random challenge value N, and so as to transfer it in safe, the value T:=Enc(SK|RPK) encrypted with the remote registration wireless channel public key RPK extracted for the sake of transferring it in safe is calculated. The response value RS obtained by binding the calculated H and T and the service server ID(IDs) and the user ID(IDs) is transferred to the mobile authentication server (MAS) by way of the PKI password channel open to the server. The mobile authentication server (MAS) calculates the RPK value like the user from the user ID information, and the result value SK is calculated, which is obtained by way of the decryption process from the value T transferred as a key value.

The hash value H*:=Hash(IDs, SK*,N) is calculated for the sake of the authentication check using the SK* and its ID value, and

the above mentioned value is compared with the received value H. When H=H*, the SK is registered, and otherwise the registration is rejected, and the wireless communication terminal is authenticated.

7) When the authentication is succeeded, the mobile authentication server (MAS) transmits a completion response message to the user wireless communication terminal, and the wireless communication terminal, which has received it, performs a step that the mobile authentication server (MAS) ID used to register itself is recorded and registered in safe in the interior, so the registration of the mobile authentication server of the wireless communication terminal is completed.

The conventional hardware OTP device needs to purchase the OTP authentication device (Tongul portable device) with which the user can generate an authentication code, and the user always carry it whenever a financial work is needed. It is needed to exchange the battery when it is fully discharged, about one time every three years. When the wireless communication terminal is used, it is needed to download the OTP generation program implemented in the VM method without needing additional costs. Even though the user who handles all kinds of the financial transactions always carries the wireless communication terminal, the user can comfortably use the OTP service.

As described above, when the initial (initialization) key setup is completed at the time of the issuances of the user authentication, the user can registers the use of the software type OTP authentication module of the wireless communication terminal, and an online remote registration by way of the internet is possible.

The double component authentication, which is being emphasized for the sake of the security enforcement of the recent electronic financial transaction, is focused on the user authentication of the financial organization. As the threats from Trojan horse, key log, fishing, farming, etc. increases, there is increasing demands that the user might need a two-way authentication by which a user can check whether or not the internet site provided from the bank is trusty. The two-way authentication features in that only the user is not authenticated from the bank, and the financial organization site should be authenticated from the users.

For the sake of the OTP service, each financial organization performs an authentication work by separately installing the OTP authentication server; however the users need to purchase and carry a plurality of OTP devices with respect to multiple financial organizations, which causes a lot of inconveniences. To improve the above mentioned problems, when one OTP is registered, different organizations share it, and the establishment of the OTP integrated authentication center is needed for the sake of integrally authenticating each OTP device issued from multiple organizations. The introduction of the OTP is widely activated along with the systematic management by binding the OTP authentication system.

For the sake of the user's financial transaction, the OTP code is generated and is connected to the DB server, and the connected user's OTP code is certified by the authentication sever of the financial organization or the authentication is performed by the OTP integrated authentication server, and a result of the authentication is transferred. In addition, the management business system manages the OTP device issuance and registration for the sake of the cooperation with respect to the OTP device with the financial organization, and an additional operating work system is operated for the sake of the control or monitoring and backup.

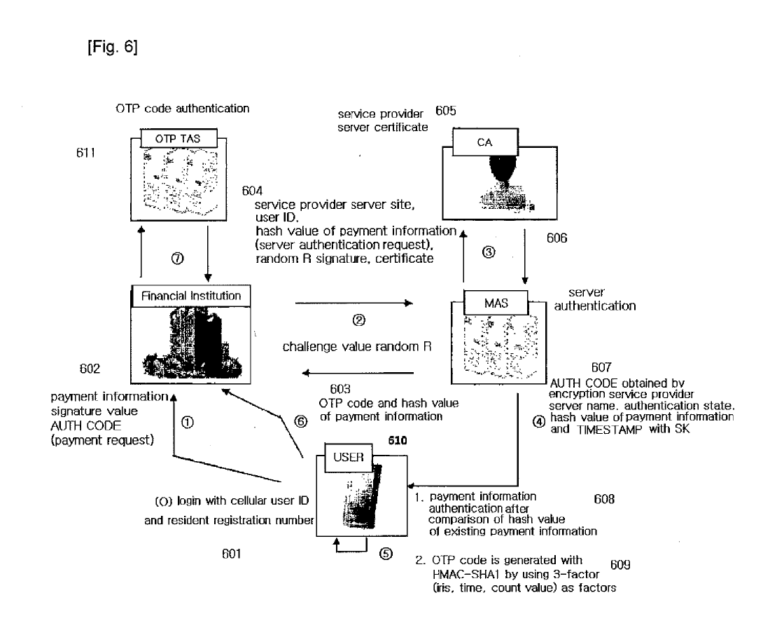

FIG. 6 is a flow chart of the whole procedures of the mutual-authentication using the OTP authentication module of the wireless communication terminal of FIG. 4 according to the present invention. The procedures as follows.

1) The wireless communication terminal has an access for the sake of the service (financial) work, and the basic user authentication is performed (S601).

2) The transmission of AUTH_CODE is requested to the service provider (financial organization) server (S602) along with the payment information and the signature value of the payment information before the payment of a corresponding service.

3) The service provider (financial organization) server requests the authentication of the service provider (financial organization) server to the mobile authentication server (MAS) using the basic challenge response method with the certificate of a corresponding service provider (financial organization) server, and transmits the user's ID value and the hash value of the payment information (S604).

4) The mobile authentication sever (MAS) authenticates (S606) the signature of the service provider (financial organization) server by way of the certificate authority (CA).

5) The mobile authentication server (MAS) generates RPK with a wireless communication terminal number corresponding to the ID of the user who has requested an authentication, and the response value T between the mobile authentication server (MAS) and the wireless communication terminal device is decrypted, and SK is calculated, and the authentication state, the hash value of the payment information and TimeStamp are encrypted and transmitted (S607).

6) The wireless communication terminal decrypts the transmitted data using a previously stored SK and compares the TimeStamp value and compares the Hash value of the previously generated payment information with the transmitted code and authenticates the payment information with respect to a corresponding bank (S608). If the payment information is matched, the wireless communication terminal generates an OTP value. The OTP code generated by the wireless communication terminal and the Hash value of the payment information are transmitted to the service provider (financial organization), thus requesting payment (S609).

7) The service provider (financial organization) server compares the payment information with the previously received payment information. If matched, the OTP code value and the Hash value of the payment information are transmitted to the OTP integrated authentication server (OTP TAS) and request an authentication (S610).

8) The OTP integrated authentication server compares the Hash value of the payment information with the code which has requested the authentication by generating the OTP code, and reports a result of the authentication to the service provider (financial organization) (S611).

The following descriptions relates to the detailed descriptions on the whole mutual-authentication procedures using the OTP authentication module of the wireless communication terminal of FIG. 6 of the present invention.

The following reference characters are used for the simplification.

U: user, S: service provider or server, ID: identifier of ID user, IRIS: iris of user, UPIN: personal information of user, T: synchronized time clock, C: synchronized counter, OTP: 6 digit OTP value.

h( ) Hash function, HMACK ( ) HMAC function, trunc ( ) 6-digit OTP value extraction function

0. The wireless communication terminal makes an access for the sake of a service (financial) work and has a basic user authentication passed.

In more details,
When the wireless communication terminal drives the user authentication module, the user iris information input is required, and when the wireless communication terminal inputs a user iris information, the features of the user iris information is in real time extracted, and the extracted value is compared with the user iris information feature value previously calculated and stored at the time the initial (initialization) key is setup for the sake of the software type OTP user authentication registration, so the user is authenticated. In the above step, the previously calculated and stored PriK is used when encrypting TransferInfo.
The user identity check information, which was submitted offline, is inputted into the service provider (financial organization) server, thus completing a membership registration. The cellular phone number is registered as a user ID.
The user ID and the resident registration number are inputted for the sake of a login and a user authentication is performed.

1. Before a corresponding service payment, the AUTH_CODE transmission is request to the service provider (financial organization) server along with the payment information and the signature value of the payment information.

In more details,

the user transmits the REQUEST_AUTH_CODE along with the payment information and the signature value of the payment information so as to request an mutual-authentication from the wireless communication terminal to the service provider (financial organization) server.

Payment information:=(money withdrawal bank money withdrawal account|amount of money withdrawal|money deposit bank|money deposit account)

TransferInfo:=Hash (payment information)

SIG_TransifInfo=E_pinK[hash (payment information)]
Transmission information=REQUEST_AUTH_CODE|SIG_TransferInfo|TransferInfo

2. The service provider (financial organization) server requests the authentication of the service provider (financial organization) server to the mobile authentication server (MAS) using the basic challenge-response method having the certificate of a corresponding service provider (financial organization) and transmits the user ID value and the Hash value of the payment information.

In more details,

The service provider (financial organization) server authenticates the payment information signature value received from the user and stores TransferInfo. It transmits a service provider (bank) name and an access user ID and TransferInfo to the MAS for the sake of an authentication, and the mobile authentication server (MAS), which has received it, generates a Challenge value random R and transmits for the sake of the authentication of the service provider (financial organization) server. The service provider (financial organization) server verifies the random R and transmits along with the certificate.

SIG_R:=Eprik(Rand_R]

3. The mobile authentication server (MAS) authenticates the signature of the service provider (financial organization) server by way of the certificate authority (CA).

In more details,

The mobile authentication server (MAS) verifies the SIG_R for the sake of opening the received certificate of the service provider (financial organization) server, and the authentication is succeeded, the certificate is transmitted to the certificate authority (CA) and verifies again the validity of the certificate.

4. The mobile authentication server (MAS) generates RPK with the wireless communication terminal corresponding to the ID of the user who has requested an authentication and calculates SK by decrypting the response value T between the previous mobile authentication server (MAS) and the wireless communication terminal device and encrypts, using the key, the authentication state, the Hash value of the payment information and the TimeStamp and transmits them.

In more details,

The MAS transmits AUTH_CODE to the wireless communication terminal of the user corresponding to the ID that was received from the verified service provider (financial organization) server.

AUTH_CODE:=E_sk (service provider (financial organization) name|ACCEPT or DENY|TimeStamp|TransferInfo)

5. The wireless communication terminal decrypts the transmitted data using the previously stored SK and compares the TimeStamp value and compares the Hash value of the previously generated payment information with the transmitted code and authenticates the payment information with respect to a corresponding service provider (financial organization). If the payment information is matched, the wireless communication terminal generates the OTP value.

In mode details,

AUTH_CODE is received from the wireless terminal of the user, and it is decrypted using a sk key.

The validity of TimeStamp is compared, and if it is TransferInfo value, the OTP code is generated.

OTP code generation algorithm

In order for the time when the OTP code generation request event has occurred to be indicated, the Time Interval of all the time regions is determined at an interval of 30 ms.

In the course of a 3-factor authentication process, the iris information, time and count time are used, and HMAC algorithm is used.

In addition, the value obtained by secondarily hashing the iris information is used like the key of HMAC, and a 6-digit OTP value is generated by DTing the square function.

PreTimeInterval: A start time of the interval having the timing when the OTP code generation request event has occurred.

PostTimeInterval: An end time of the interval having the timing when the OTP code generation request event has occurred.

SK: A secret key which is inherently included in the OTP authentication module of the wireless communication terminal.

C: The counter value synced with the service provider (financial organization) server.

Serial: hash (PreTimeInterval|PostTimeInterval|TransferInfo)

TempCode=HMAC-SHA1 (serial, C, SK)

HMAC: Hashed Message Authentication Code

OTP code=DT(TempCode) DT: Dynamic Truncation

If it is assumed that P1 is an OTP code generation event timing,

PreTimeStamp=x−30, PostTimeStamp=x

When an OTP generation code event occurs at P1, the OTP authentication module generates an OTP code corresponding to Time Interval T2.

6. The payment is requested by transmitting the OTP code generated at the wireless communication terminal and the value obtained by hashing the payment information to the service provider (financial organization) server.

In more details,

The user transmits the OTP code generated at the wireless communication terminal and the value obtained by signing TransferInfo to the service provider (financial organization) server.

Payment information:=(money withdrawal bank|money withdrawal account|amount of money withdrawal|money deposit bank|money deposit account)

TransferInfo:=Hash (payment information)

SIG_TransferInfo=E_priK [Hash (payment information)]

7. The service provider (financial organization) server compares the payment information with the previously received information and when they are matched, it requests the authentication by transmitting the OTP code value and the Hash value of the payment information to the OTP integrated authentication server (OTP TAS).

In more details,

The service provider (financial organization) server compares the transferInfo received from the user with the previously received TransferInfo. When two values are matched, the signature value authenticates the SIG_TransferInfo and performs verification. If two verifications are passed, the service provider (financial organization) server requests an authentication by transmitting the OTP code received from the user and the TransferInfo to the OTP integrated authentication server (OTP TAS).

8. In the OTP integrated authentication server, the Hash value of the payment information and the OTP code are generated and are compared with the codes which have requested the authentication, and the authentication state is reported to the service provider (financial organization) server.

The code generated at the wireless communication terminal is transmitted to the OTP integrated authentication server (OTP TAS) by way of the service provider server within a corresponding interval time. The time taken for the OTP code to be transmitted to the OTP integrated authentication server (OTP TAS) is within 1 second theoretically. The OTP TAS shares the interval value of the P1 timing when the event has occurred in a corresponding wireless communication terminal. The OTP TAS can authenticate the OTP code with PreTimeInterval based on a corresponding Interval section, a PostTimeInterval value and a secret SK value shared between the corresponding wireless communication terminals, a counter value C and a received transferInfo.

In addition, the authentication is passed, the wireless communication terminal and OTP TAS calculates C=C+1 and newly synchronizes the counter. At this time, when ΔT of the OTPTAS and the wireless communication terminal are exceeded, the synchronized counter C is initialized.

In case that the financial organization itself manages the authentication server, the user makes an access to a corresponding financial organization and receives an authentication by way of the authentication server itself. In addition, an information is transmitted for the sake of a synchronization with the authentication server of the integrated authentication center so that the OTP code, which was once used, cannot be authenticated from another organization. A result of the authentication is transmitted to the user after checking the synchronization.

In case that a corresponding financial organization is not equipped with the authentication server, the financial organization transmits the OTP authentication code received from the user to the OTP integrated authentication server for having an authentication issued, and a result of it is reported to the user. In addition, the authentication server of the OTP integrated authentication center transmits a result of the authentication to a corresponding financial organization for the sake of a synchronization with the authentication server of the financial organization so as to induce the synchronization.

Next, the stability on the attack scenario with respect to the authentication method of FIG. 6 according to the present invention will be described.

A. In case of the internet banking using OTP, even though a hacker installs Trojan horse virus in the personal computer and steals an ID/password, a certificate and a private key, since it is impossible to reuse the OTP code which changes for each payment, the hacking in case of the internet banking is using OTP cannot be challenged.

B. Even though the hacker transmits an authentication code to the wireless communication terminal of the user by forging the signature of the payment information in the course of (1) and disguising it with the MAS (mobile authentication server), the hacker cannot generate an authentication because the hacker cannot find out the secret key between the wireless communication terminal and the MAS.

C. In case that a hacker induces the authentication of the normal user by using a fishing method or a farming method, the hacker might intercept the OTP code generated in the user's personal computer while maintaining the transaction information of the user without converting it. Thereafter, even though the hacker tries the traction with a new cession so as to use within 30 ms with the new session in a state that the normal user's connection is cut off, since the hash value of the transaction information made during the generation of the OTP is different from the transaction information, the OTP authentication center generates an authentication error with respect to the OTP code in (Auth 3), so the payment cannot be normally processed and completed.

In more details,

A. To achieve the objects, the present invention should prove that the transaction is safe from the retransmission attack, the collision possibility of the single direction hash function and the OTP token physical attack which are the security requirements with respect to the authentication method.

1) Retransmission Attack

Even through the attacker disguises to the user A using the message obtained during the previous session and transmits the message to the server and intercepts the message that was sent from the user B to the user A, the attacker cannot calculate the previous OTP value because the attacker cannot find out the ID, the iris information and the user PIN value that the user provided to the server in the registration step.

Therefore, since the proposed authentication method uses the counter C synchronized with the time clock T synchronized by the conventional authentication method, the OTP can be used only when the counters C synchronized within ΔT are matched. So, the authentication method of the present invention is safe from the retransmission attack.

2) Collision Possibility of Single Direction Hash Function

The present invention is hard to calculate and find out the keys or the pair of collisions used from the MAC value given based on the HMAC. At this time, any hash function safe from the encryption can be used for the sake of the hash function of HMAC.

3) Physical Attack to the OTP Token

The present invention is directed to generating an OTP using the iris information of the user. Even though a malicious user obtains the OTP token of other users, since it is impossible to copy the iris information perfectly, the generation of the same OTP as the owner of the OTP token is impossible. So, the physical attack can be prevented.

Attack from Tapping

Since the message transmitted from the proposed protocol is the OTP value generated by means of HMAC, it is impossible to obtain useful information by way of the tapping in a simple way.

So, the authentication structure of the present invention is safe from the tapping attack.

5) Password Attack from Guess

The password guess attack can be divided into an online password guess attack and an offline password guess attack. As for the online password guess attack, since the OTP received from the user U is compared with the OTP′ made by the server S, and when they are same, the service is provided, but when they are not same, the service is not provided, so the present invention is safe from the password guess attack. Guessing the password based on the protocol of the present invention is impossible thanks to the single direction of the hash function.

6) Secret Key Guess Attack to Server

The secret key guess attack to the server is like the password guess attack. The attacker is directed to guessing the information of the secret key of the server from the messages that the attacker taps the legal user; however guessing the secret key of the server from the information is impossible thanks to the single direction of the hash function. So, the authentication structure of the present invention is safe from the secret key attack of the server.

7) Disguise Attack

For a legal user or an attacker to disguise others, it is needed to know the user's ID and password of the user who he wants to disguise to. It is easy to get the open information of the user; however the user's password can be obtained by calculating I=HMAC h (fin) (T) (C) and extracting OTP′=trunc(I′), so it is impossible to guess thanks to the single direction of the hash function. So, the disguised attack is impossible.

The analysis on the efficiency on the protocol of the present invention needs one time initialization process which is same as the ordinary password method. It does not have any limitation in the number of uses. In addition, since the number of the hash calculations is fixed to 4 times, there is not any load on the over head. Since the S/Key system generates an OTP using a serial number, the number of the uses is limited to a n-number in the course of the initialization, so when the set range is exceeded, the initialization is performed again, which cause inconveniences. The password might be leaked in the course of the initialization. The protocol of the present invention does not use the serial number, instead calculates C=C+1 for U and S, and the counter is newly synchronized. At this time, when the ΔT of the server S and the user U is exceeded, the synchronized counter C is initialized to 0.

In addition, the safety and efficiency should be verified by comparing and analyzing the uses of ordinary passwords, the S/Key method and the proposed OPT so as to achieve the objects of FIG. 6 of the present invention.

The performances and functions will be first analyzed.

First of all, the proposed protocol does not have a calculation process which might be costly while influencing the modern computing technology like the exponent calculation or the encryption calculation, so the analysis with regard to the performance is meaningless.

In view of the functions, the proposed protocol generates an OTP by using the biological information of the user and HMAC.

Therefore, in view of the functions, it is more efficient than the ordinary password method and S/Key system with respect to the physical attacks such as the collision of the single direction hash function and the OTP token.

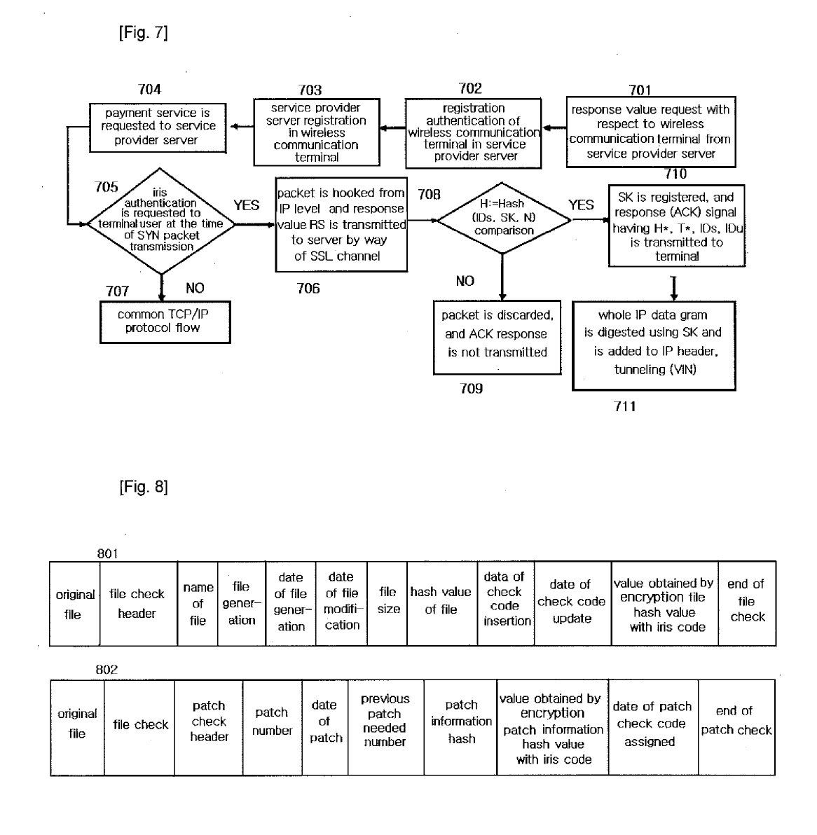

FIG. 7 is a flow chart of a packet level user authentication method using an iris data for the purpose of preventing a DoS attack on a network section between a wireless communication terminal and a service provision server communication module part.

(1) The response value request step (S701) with respect to the wireless communication terminal from the service provider server. For the sake of the user registration, a SSL and PKI-based safe encryption channel is formed between the user's wireless terminal and the service provider server. When a safe channel is formed by way of it, the service provider server generates a random number challenge value N for the sake of the user authentication and transmits it along with the server ID itself to the user wireless communication terminal, and the user wireless communication terminal generates a response value with respect to the ID transmission of the service provision and the random number challenge value N.

As the basic response value calculation step, the hash value H:=Hash(IDs, SK, N) is calculated with respect to the ID(IDs) of the provision server and the random challenge value N using the stored SK using the iris information. The encrypted value T:=Enc(SKRPK) is calculated using the remote registration channel master key RPK extracted from S252 so as to transfer in safe.

2) The next step is directed to a registration authentication step of the wireless communication terminal in the service provider server. The wireless communication terminal transmits the response value RS obtained by binding the calculated H and T and the service provider server ID(IDs) and the user ID(IDu) to the service provider server by way of the PKI password channel which is already open to the server, and the service provider server calculates the RPK value like the user from the user ID information and calculates the result value SK* obtained by way of the decryption process from T which receives as the key value.

The hash value H*:=Hash (IDs, SK*, N) is calculated for the sake of the authentication check using the SK* and the ID value of itself.

The calculated value is compared with the value H. If H=H*, SK is registered, and otherwise the registration is denied, and the wireless communication terminal is authenticated (S702).

When the authentication is passed, the service provider server transmits a completion response message to the user wireless communication terminal, and the wireless communication terminal, which has received it, performs a step for recording and storing in safe in the service provider server ID which has registered itself, so the service provider server registration of the wireless communication terminal is completed (S703).

(3) The wireless communication terminal requests a payment service to the service provider server (S704).

(4) The service provider server determined whether or not to request an iris authentication during the SYN packet transmission and transmits a result of the determination (S705). If the iris authentication is not requested at the time of the SYN packet transmission, the routine is performed based on the common TCP/IP protocol (S707).

(5) The service provider server which has requested the iris authentication hooks at the IP level when the SYN packet including H and T and the service provider server ID (IDs) and the user ID (IDu) is received from the wireless communication terminal for the sake of a payment service request (S706), the service provider server calculates the RPK value like the user from the user ID information and calculates the result value SK* obtained in the course of the decryption process from T which is received as the key value. The hash value H*:=Hash (IDs, SK*, N) is calculated for the sake of the authentication check by using SK* and its ID value, and the calculated value is compared with the received value H. As a result of the comparison, if H=H*, SK is registered (S708), and otherwise the registration is denied (S709) in the comparison process.

(6) If the authentication is passed, the service provider server transmits to the wireless communication terminal the response (ACK) signal including H* and T* calculated in the comparison process and the service provider server ID(IDs) and the user ID(IDu).

If the authentication is not passed, the service provider server discards the packet, so that the TCP does not transmit an Acking SYN response, by which the DoS attack can be prevented, and the valid port search can be prevented.

(3) The wireless communication terminal which receives the ACK signal from the service provider server repeats the process of (4).

(8) The wireless communication terminal user and the service provider server digest the whole data grams using the symmetric key SK registered in the above process, and a result of the digest is attached and transmitted. It is included in the TCP/IP protocol stack and is transmitted (S711).

The procedure that the iris information is inserted into the TCP/IP protocol stack will be described. At the IP level, the packet is hooked and the iris information is inserted, and a tunneling ring is adapted for the purpose of providing VPN (Virtual Private Network) function. In other words, it is inserted during the SYN, Acking SYN packet transmission among the TCP 3-way handshake. It is encrypted except for the user ID and is transmitted.

The format when transmitting the Acking SYN packet features in that the packet is hooked before the packet is fractured in the IP hierarchy, and the iris information is inserted and is encrypted.

A new IP header is added for the sake of tunneling.

In the packet level user authentication part of FIG. 7 according to the present invention which is directed to maintaining the integrity by way of the security and iris information of the wireless communication terminal operating system from various malicious codes and viruses which penetrate by way of the process based on the common TCP/IP protocol flow since the iris authentication is not requested when transmitting the SYN packets, the present invention provides various security characteristics using a single security application (or a set of security processes) for the purpose of monitoring and protecting the virtual machines which are emulated by multiple logics executed on the wireless communication terminal system.

FIG. 8 shows the check of the original files and the check DB records of the patch files checked for the purpose of maintaining the security and integrity of the wireless communication terminal operating system. In the wireless communication terminal comprising a main memory storage of which a security application communicates with the processor, an auxiliary storage device, a network card, and an operating system, the security processes having a certain level of the access and visibility can be provided to the components of the virtual machines comprising at least one emulated virtual memory, a virtual disk, a virtual network adapter, a virtual driver (for example, a data structure or object models in the memory). The checks of the original file and the check DB records of the patch file are generated for the sake of the integrity of the available files, and the integrities are checked if necessary by searching it.

1) Original file check component record structure: original file, file check header, file name, file generation date, file modification date, file size, file hash value, check code insertion date, check code update date, value encrypted with file hash value iris code and file check end (S801).

2) Patch file check component record structure: original file, file check, patch check header, patch number, patch release date, prior patch necessary number, patch information hash, value encrypted with patch information hash value, file check-assigned date and patch check end (S802).

According to a certain embodiment of the present invention, the wireless communication terminal system can generate periodic image files of whole states of each virtual machine. Theoretically, the image file can be instantly processed with a slight performance overhead; however there might be a lot of variables in the above technology.

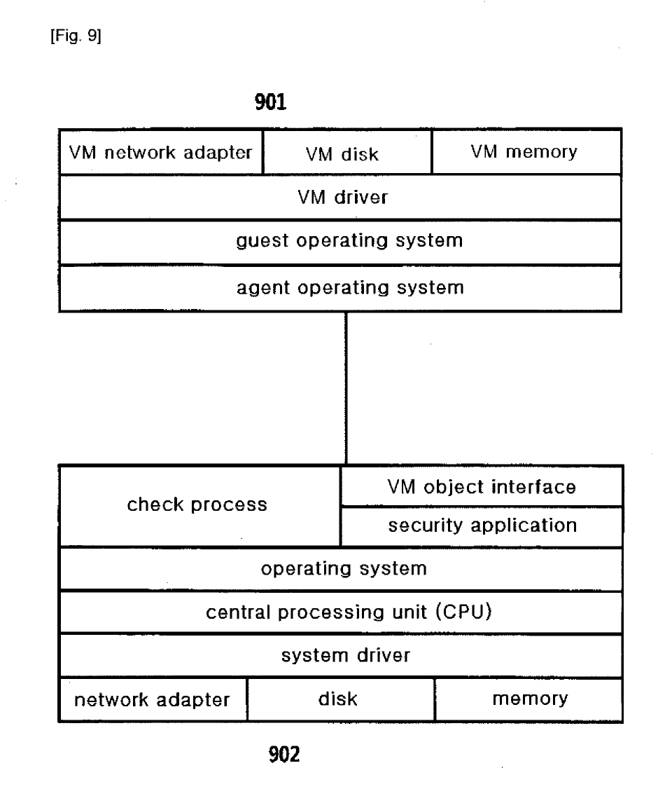

FIG. 9 is a view illustrating a virtual machine and a terminal physical system for the sake of the security of the wireless communication terminal operating system according to the present invention. In the embodiments of the present invention, the wireless communication terminal system executable on the physical machine provides virtual machines which can be executed by the operating system and the applications. A lot of processes can be executed on the virtual machine; however the operating system and the applications which are executed on the virtual machines cannot access the resources (for example, memory and devices) except for the occasions that such accesses are allowed by the wireless communication terminal system providing the virtual machines and when such accesses are designated by the quests allocated to the virtual machines.

When the virtual machine executes the malicious software, the occurring damages are limited to the operating systems of the virtual machines, the applications and the access-possible resources. In this manner, the wireless communication terminal can be actually protected from the malicious softwares which are executed on the virtual machines. (S901).

According to the embodiments of the present invention, the security processes can be implemented on or controlled by the monitoring processes which are executed on the wireless communication terminal system. The monitoring process can provide the security processes having a certain level of access and visibility to the components of the virtual machines having a virtual memory, a virtual disk, a virtual network adapter, a virtual driver (for example, data structure in memory and object models) or can make them usable. For example, the monitoring process can be allowed to search the data structure stored on the disk corresponding to the virtual hard disk of the virtual machine or in the memory for the security process to search for the malicious software or the sign of the security destroy. Alternatively, when the object model supported by the wireless communication terminal system is provided, the monitoring process can return the information on the states of the virtual machines (memory state or communication state) to the wireless communication terminal system. (S902).

The wireless communication terminal system and monitoring process provide a certain level of isolation and independency, so the accesses to the harmful programs executed on the virtual machines remain still impossible while managing and monitoring the virtual machines. In this manner, the security processes can be protected from the tempering and destroy with the aid of the programs which have given monitoring functions to them.

When the security process detects the abnormal states in the virtual machines (for example, malicious software which is overwritten on the operating system and malicious software which disguises itself as a program residing in the memory), as a method for protecting the operating system of the wireless communication terminal system from the damages caused by the harmful process operations, the step for stopping the kernel and the step for checking the kernel so as to determine whether or not there is an evidence in the operations of the processes is performed by means of the monitoring process separated from the partially isolated operating system.

According to the embodiments of the present invention, at least one virtual machine can be executed under a control of the wireless communication terminal system and can be dependent to the wireless communication terminal system. Each virtual machine might be formed of a set of components which virtualizes and emulates a process and other machine resources. For example, according to the disclosed embodiments of the present invention, the virtual machines has an access with respect to a set of the resources, which are emulated, having at least one virtual driver representing a virtual network adapter, a virtual memory (it might be formed of allocated portions of the memory of the physical machine), a virtual disk and a virtual instance of non-virtual drivers. Here, the virtual operating system instance is executed on the above mentioned virtual machines. According to the embodiments of the present invention, the virtual operating system instances might be whole or partial colony components of the operating system of the physical machine.

The virtual machines might be generated on the wireless communication terminal system or might be executed thereon using a certain one among available technologies.

For example, according to the embodiments of the present invention, the wireless communication terminal system generates the instance of the virtual machine and launches it and can configure the parameters with respect to the virtual machines when generating them. According to the embodiments of the present invention, the wireless communication terminal can search for the conventional virtual machine images on the disk (perhaps, when it is shared) and the image can be loaded as a new virtual machine instance.

1. A three-factor user authentication method for generating an OTP using an iris information, comprising:
an initial offline face-to-face identity check part for issuing a user OTP authentication module of a wireless communication terminal;
an iris camera taking a user iris image of the wireless communication terminal;
an iris information process part extracting the features of an iris information and performing a digital coding process;
a security module part authenticating a user using an iris digital code for the sake of a registration and mutual-authentication of the user OTP module of the wireless communication terminal and generating an OTP and performing an encryption process;
a communication module part transmitting and receiving a data between the wireless communication terminal and the service provider server and the mobile authentication server (MAS);
a packet level user authentication part using an iris data for preventing a denial of service (DoS) attach on a communication line;
a program memory storing an encryption algorithm and an operating program and a storing part storing the encrypted key values; and
a security application execution part helping easily scan the virtual resources for detecting the malicious processes accessing the emulated virtual resources of multiple instances as a method for monitoring and protecting the multiple instances under the included process execution environment, and executing at least one security application providing an access to the related virtual hard disk and the virtual network adapter structure and the related virtual driver structure.

2. The method of claim 1, wherein the initial face-to-face identity check step for issuing the user OTP authentication module of the wireless communication terminal includes a step for requesting a user identity check information and an ID card (resident registration number) such as a user account number, a wireless communication terminal number (used as a user ID), an e-mail address and a user PIN and checking it face to face.

3. The method of claim 2, wherein the cellular phone number is used as a user ID.

4. The method of claim 2, wherein the user PIN (Personal Identification Number) is formed of at least one selected from the group consisting of a platform information (PFN) of a user's wireless communication terminal on which is mounted an OTP authentication module, a serial number (ESN), a communication company information, a terminal model information, an inherent serial value attached or built-in at the time of manufacture of an OTP authentication device, an IC chip inherent information (ICCHIP), a SIM information, a UIM information, and a USIM information.

5. The method of claim 1, wherein the security module part comprises:
an initial (initialization) key setup step for the sake of a user OTP authentication registration of a wireless communication terminal; and
an mutual-authentication registration step using an OTP authentication module of a wireless communication terminal.

6. The method of claim 5, wherein the initial (initialization) key setup step for the sake of a user OTP authentication registration of the wireless communication terminal comprises:
a step for extracting a feature from the iris information of the user by means of the iris process part;
a conceal master key (CK) generation step by a security module part;
a user private key(PriK) generation step;
a software type OTP generation secret key (SK) generation step;
a step for generating a remote registration wireless channel public key (RPK) for a remote registration;
a wireless communication terminal response value request step to the mobile authentication server (MAS);
a registration authentication step of the wireless communication terminal; and
a step for inputting a related information into a personal computer by way of the communication module part.

7. The method of claim 6, wherein the conceal master key (CK) generation step features in that an iris feature code of a user is obtained in real time, and the iris code is not stored, and the iris code value on the first track coordinate of a reference angle (sector) is determined as a filter, and a key/code allowing the iris information to be concealed and the encryption key to be concealed is defined as a CK (Conceal Key), and a hash value using the user PIN value and the generated iris filter value as the factors is obtained, thus generating a CK value.

8. The method of claim 6, wherein the user private key (PriK) and the software type OTP generating secret key (SK) generation step features in that when the CK value is calculated, the hash value with respect to the value is calculated, thus generating a private key value (PriK), and the second hash value is calculated with reference to the private key value (PriK), thus generating a secret key (SK) for the software type OTP generation.

9. The method of claim 6, wherein the step for generating a remote registration wireless channel public key (RPK) is directed to generating a remote registration wireless channel public key (RPK) value by calculating a hash value induced from the cellular phone number of the wireless terminal.

10. The method of claim 6, wherein the wireless communication terminal response value request step to the mobile authentication server (MAS) features in that a SSL and PKI-based safe encryption channel is formed between the wireless terminal of the user side and the mobile authentication server (MAS) server, and when a safe channel is formed thereby, the mobile authentication server (MAS) generates a random number challenge value N for the sake of a user authentication and transmits to the user mobile communication terminal in safe along with the server ID of itself.

11. The method of claim 6, wherein the registration authentication step of the wireless communication terminal features in that the user wireless terminal performs an ID transmission of the MAS and generates a response value with respect to the random number challenge value “N”, and as the basic response value calculation step, a hash value H:=Hash(IDs, SK, N) with respect to the ID(IDs) of the MAS and the random challenge value “N” are calculated, and so as to transfer it in safe, a value T:=Enc(SK|RPK) encrypted with the extracted remote registration wireless channel public key RPK is calculated, and the response value RS obtaining by binding the calculated H and T and the service server ID(IDs) and the user ID(IDu) is transmitted to the MAS by way of the PKI encryption channel already open to the server, and the MAS calculates the RPK value like the user from the user ID information, and from T which receives it as a key value, the result value SK* obtained by way of the decryption process, and the Hash value H*:=hash(IDs, SK*, N) is calculated for the sake of the authentication check using SK* and the ID value of itself, and it is compared with the received value H, and if H=H*, SK is registered, and otherwise the registration is denied, thus authenticating the wireless communication terminal, and when the authentication is passed, the MAS transmits the completion response message to the user wireless communication terminal, and the wireless communication terminal, which receives it, performs a step for recoding and storing in safe the MAS ID in the interior which has registered it, thus completing the wireless authentication server registration of the wireless communication authentication terminal.

12. The method of claim 1, the communication module part is formed of one selected from the group consisting of a wired or wireless USB, a zigbee module, a bluetooth module, a GSM module, a CDMA module, a WCDMA module, a WiBro module, a WiMax module, a WiFi module, etc. for the purpose of transmitting and receiving a data between the wireless communication terminal and the service provider server and the wireless authentication server (MAS).

13. The method of claim 5, wherein the mutual-authentication step using an OTP authentication module of the wireless communication terminal comprises:
1) a step in which a wireless communication terminal makes an access for a service (financial) work and receives a user authentication;
2) a step in which prior to a corresponding service payment, an AUTH-CODE transmission is requested along with a payment information and a signature value of the payment information to the service provider (financial organization);
3) a step in which the service provider (financial organization) server requests an authentication of the service provider (financial organization) server to the mobile authentication server (MAS) using a basic challenger response method along with a certificate of the corresponding service provider (financial organization) server and transmits a user ID value and a hash value of the payment information;
4) a step in which the MAS authenticates the signature of the service provider (financial organization) server by way of the certificate authority (CA);
5) a step in which the MAS generates RPK with a wireless communication terminal number corresponding to the ID of the user who has requested the authentication and decrypts the response value T between the corresponding wireless authentication server (MAS) and the wireless communication terminal device, thus calculating SK and encrypts the authentication state, the hash value of the payment information and TimeStamp using the key and transmits it;
6) a step in which the wireless communication terminal decrypts the received data using a previously stored SK and compares it with the TimeStamp and then compares the hash value of the previously generated payment information with the received code, thus authenticating the payment information of a corresponding bank, and when the payment information is matched, the wireless communication terminal generates an OTP value;
7) a step in which a payment is requested by transmitting the OTP code generated in the wireless communication terminal and the value hashed from the payment information to the service provider (financial organization);
8) a step in which the service provider (financial organization) server compares the payment information with the previously received payment information, and when they are matched, it requests an authentication by transmitting the OTP code value and the Hash value of the payment information to the OTP integrated authentication server (OTP TAS); and
9) a step in which the OTP integrated authentication server generates the hash value of the payment information and the OTP code and compares it with the code used to request the authentication and reports an authentication state to the service provider (financial organization) server.

14. The method of claim 13, wherein the step in which the wireless communication terminal obtains a basic user authentication by connecting for the sake of a service (financial) work comprises:
1) a step in which it is verified whether or not a user is proper in such a way that when a user authentication module is driven in the wireless communication terminal, the user iris information input is requested and when the wireless communication terminal inputs the user iris information, the features of the user iris information is extracted in real time, and the extracted value is compared with the user iris information feature value calculated and stored during the initial (initialization) key setup for the sake of the software type OTP user authentication registration, thus authenticating the proper user;
2) a step in which the member registration is completed by inputting the user identification check information submitted offline to the service provider (financial organization) server, and the cellular phone number is registered as the user ID; and
3) a step in which the basic user authentication is performed by way of a login by inputting the user ID and the resident registration number.

15. The method of claim 13, wherein the step for requesting AUTH_CODE transmission along with the payment information and the signature value of the payment information prior to a corresponding service payment to the service provider (financial organization) server features in that the user transmits REQUEST_AUTH_CODE and the value (TransferInfo) hashed from the payment information (money withdrawal bank|money withdrawal account|amount of withdrawal money|money deposit bank|money deposit account) and TransferInfo to the service provider (financial organization) along with the user private key (PriK) and the signature value.

16. The method of claim 13, wherein the service provider (financial organization) server requests an authentication of the service provider (financial organization) to the mobile authentication server (MAS) using the basic Challenge-Response method with the certificate of the corresponding service provider (financial organization) and the ID value of the user and the hash value of the payment information are transmitted, and in the above step, the service provider (financial organization) server authenticates the payment information signature value from the user, and the value (TransferInfo) hashed from the payment information is stored, and for the sake of the authentication to the MAS, the name of the service provider (bank) and the access user ID and TransferInfo are transmitted, and the MAS which receives it generates and transmits the challenge value random R for the sake of the authentication of the service provider (financial organization) server, and the service provider (financial organization) server makes a signature on the random R and transmits it along with the certificate.

17. The method of claim 13, wherein the step in which the MAS authenticates the signature of the service provider (financial organization) server by way of the CA features in that the MAS verifies SIG_R received along with the signature made on the random R with the public key of the certificate of the service provider (financial organization) server, and if the verification is passed, the certificate is transmitted to the CA, thus verifying again the validity of the certificate.

18. The method of claim 13, wherein the step in which the MAS generates RPK with the wireless communication terminal number corresponding to the ID of the user who has requested the authentication, and the response value T is decrypted between the previous MAS and the wireless communication terminal, thus calculating SK, and the authentication state, the hash value of the payment information and TimeStamp are encrypted using the key and transmitted features in that the MAS transmits AUTH_CODE encrypted with SK along with the name of the service provider (financial organization) server, the authentication state of the key and TimeStamp TransferInfo to the wireless communication terminal of the user corresponding to the ID from the verified service provider (financial organization) server.

19. The method of claim 13, wherein the wireless communication terminal decrypts the received data using a previously stored SK and compares TimeStamp value and compares the hash value of the previously generated payment information with the received code, and authenticates the payment information with respect to the corresponding service provider (financial organization) server, and the step in which if the payment information is matched, the OTP value is generated at the wireless communication terminal features in that the wireless communication terminal of the user received and decrypts AUTH-CODE with sk and compares the validity of TimeStamp, and if it is TransferInfo value, the OTP code is generated.

20. The method of claim 19, wherein the method for generating the OTP code features in that for the sake of the 3-factor authentication process, the iris information, the time, the count value are used, and the HMAC algorithm is used, and at this time, the SK value obtained by second hashing the iris information is used as the key of HMAC, and for the sake of the indication of the time when the OTP code generation request event has occurred, the Time Interval section of all the time regions is designated at an interval of 30 ms, and when P1 is assumed to be an OTP code generation event timing, PreTimeStamp=x−30, and PostTimeStamp=x, and the counter value=C in sync with the service provision (financial organization) server, the serial value obtained by hashing the information including PreTimeInterval, PostTimeInterval, TransferInfo and the MAC value TempCode (for example, 20 byte string) obtained by hashing HMAC-SHA1 using the SK as a factor are calculated, and the TempCode is processed by a Dynamic Truncation by way of the square function, thus generating an OTP code (for example, 6-byte string) corresponding to the Time Interval T2.

21. The method of claim 13, wherein the step in which the payment is requested by transmitting the OTP code generated in the wireless communication terminal and the value obtained by hashing the payment information to the service provider (financial organization) server features in that the OTP code generated at the user wireless communication terminal and the value from the signature of TransferInfo obtained by hashing the payment information are transmitted to the service provider (financial organization) server.

22. The method of claim 13, wherein the step in which the service provider (financial organization) server compares the payment information with the previously received payment information, and when matched, the authentication is requested by transmitting the OTP code value and the hash value of the payment information to the OTP integrated certificate server (OTP TAS) features in that the service provider (financial organization) server compares TransferInfo from the user with the previously received TransferInfo, and if two values are matched, the verification is performed by authenticating SIG_TransferInfo of the signature value, and if two verifications are matched, the service provider (financial organization) server transmits the OTP code and TransferInfo from the user to the OTP integrated authentication server (OTP TAS) for requesting the authentication.

23. The method of claim 13, wherein the step in which the OTP integrated authentication server generates the OTP code along with the HASH value of the payment information and compares it with the code which has requested the authentication and reports the authentication state to the service provider (financial organization) server features in that the code generated at the wireless communication terminal is transmitted to the OTP integrated authentication server (OTP TAS) by way of the service provider server within a corresponding interval time, and the time taking for the OTP code to be transmitted to the OTP integrated authentication server (OTP TAS) is theoretically within 1 second, and the OTP TAS shares the interval value of the P1 timing where the event has occurred at a corresponding wireless communication terminal, and the OTP TAS can authenticate the received OTP code using the PreTimeInterval value and PostTimeInterval value based on a corresponding Interval section and the secret key SK shared between the corresponding wireless communication OTP authentication modules, the counter value C and the received TransferInfo, and if the authentication is passed, the wireless communication terminal and the OTP TAS calculate C=C+1, and the counter is newly synchronized, and at this time, when ΔT of the OTP TAS and the wireless communication terminal is exceeded, the synchronized counter C is initialized to 0.

24. The method of claim 1, wherein the program memory storing an encryption algorithm and an operating program and the storing part storing the encrypted key values feature in that the storing places of the OTP generation program implemented in a VM method of the wireless communication terminal, the user's private key PriK generated in claim 8, the secret key SK for the sake of the generation of the software type OTP and the remote registration wireless channel public key RPK generated in claim 9 are the memory in the wireless communication terminal formed of the NAND flash memory, and the external type memory is formed of one selected from the group consisting of a CF card, a XD card, a SD card, a smart media, a memory stick and a smart card memory.

25. The method of claim 1, wherein the packet level user authentication part using the iris data for the purpose of preventing a DoS (Denial of Service) on the communication line comprises:
(1) a process in which when a wireless communication terminal requests a service to each service server, each service provider server determines whether or not to request an iris authentication during a SYN packet transmission and then transmits it and if the iris authentication is not requested during the SYN packet transmission, a common TCP/IP protocol is performed;
(2) a process in which the service provider server which received the payment service requesting an iris authentication calculates RPK line the user from the previous user ID information in case that from the wireless communication terminal are received the SYN packet including H and T calculated in the same manner as claim 11 and the service provider server ID(IDs) and the user ID(IDu), and it calculates the result value SK* obtained from the decryption process from T which is transferred as the key value, and calculates the hash value H*=Hash(IDs, SK*, N) for the sake of the authentication check using the SK* and its ID value, and the value is compared with the received H, and when H=H*, SK is registered, and otherwise the registration is denied;
(3) a process in which the service provider server, if the authentication is passed, transmits the response ACK signal including H* and T* calculated in the comparison process and the service provider server ID(IDs) and the user ID(IDu) to the wireless communication terminal;
(4) a process in which the wireless communication terminal receiving the ACK signal from the service provider repeats the process of (1);
(5) a process in which the wireless communication terminal user and the service provider server digest the whole IP data grams using the registered symmetric key SK in the above process and then attaches a result of the digest and transmits by inserting it into the TCP/IP protocol stack;
(6) a process in which the iris information is inserted into the TCP/IP protocol stack in such a way that the packet is hooked at the IP level, and the iris information is inserted, and the tunneling is adapted so as to provide a VPN (Virtual Private Network) function, and in other words, it is inserted when transmitting the SYN, Acking SYN packets among the TCP 3-way handshake, and it is transmitted after encrypting except for the user ID, and the format when transmitting the SYN Acking SYN packet is encrypted after the packet is hooked before the fracture of the packet occurs in the IP hierarchy and the iris information is inserted, and a new IP header is added for the sake of tunneling.

26. The method of claim 1, wherein the security application execution part features in that in the wireless communication terminal comprising a main memory storage communicating with the processor, an auxiliary storage device, a network card, and an operating system, the security processes having a certain level of the access and visibility can be provided to the components of the virtual machines comprising at least one emulated virtual memory, a virtual disk, a virtual network adapter, a virtual driver (for example, a data structure or object models in the memory), and DB records for the checks of the original file and the check of the patch file are generated for the sake of the integrity of the available files, and the integrity are checked if necessary by searching it, and
1) Original file check component record structure: original file, file check header, file name, file generation date, file modification date, file size, file hash value, check code insertion date, check code update date, value obtained by encrypting the file hash value with the iris conceal master key (CK) and file check end; and
2) Patch file check component record structure: original file, file check, patch check header, patch number, patch release date, prior patch necessary number, patch information hash, value obtained by encrypting the patch information hash value with the iris conceal master key (CK), file check-assigned date, patch check end, and the security application is provided, which includes a integrity by searching, if the records are necessary.

27. The method of claim 1, wherein as a way in the wireless communication terminal system to protect the operating system with respect to the damages caused by the harmful process operations, there are a step for stopping the kernel, and a step for checking the kernel so as to determine whether or not there is an evidence of the operation of the process, which process is directed to at least partially performing by means of the monitoring process separated from the operating system which is at least partially separated.
